(19) United States
(12) Patent Application Publication
(10) Pub. No.: US 2019/0043067 A1
(43) Pub. Date: Feb. 7, 2019

(54) SYSTEM AND METHOD FOR MERCHANTS TO IDENTIFY CONSUMER POSITION AND PREDICT PURCHASING HABITS THROUGH INTERACTIONS ON A SOCIAL MEDIA NETWORK

(71) Applicant: Travis Tingue, West Valley, NY (US)

(72) Inventor: Travis Tingue, West Valley, NY (US)

(21) Appl. No.: 15/668,156

(22) Filed: Aug. 3, 2017

(51) Int. Cl. G06Q 30/02; G06Q 50/00

(52) U.S. Cl. CPC G06Q 30/0203; G06Q 50/01

(57) ABSTRACT

A system and method for merchant to evaluate the position of a customer in the customer lifecycle, and create a proper response to said customer through social media networks. Method includes: providing a social media network; inputting into the social media network a sentiment, intention, and request about a merchant; if the consumer input is ignored by the merchant, responding through the social media network, the response pertinent to the ignored input; identifying the consumer response to the ignored input; contextually obtaining data about the consumer; analyzing the data from the consumer through a communication modeling system; analyzing the initial sentiment, intention, and request of the consumer through the communication modeling system; responding to the consumer a response based on the data collected from the context of the attempted communication and understanding of the customer's position in the model.

### FIELD OF THE INVENTION

The present invention relates generally to a system and method for merchant to evaluate the position of a customer in the customer lifecycle, and create a proper response to said customer through social media networks. More so, the present invention relates to a system and method that helps a merchant, business, or organization to better understand the sentiments, intentions, and requests of a consumer who is attempting to communicate with the merchant through a social media network by identifying and analyzing consumer responses after being ignored on a social media network; and whereby the merchant uses a communication modeling system to analyze consumer response and choose the most appropriate actions to address the initial sentiment, intention, and request of the consumer; and whereby the system and method highlights the potential value of responding to consumer interactions on the social media network, enabling the merchant to maintain relationships and a sense of community with a greater percentage of existing and future consumers, so as to possibly develop a consumer from a prospect to a brand ambassador, by allowing businesses to prioritize the responses to different customers, based on their potential value to the company. This is because it costs businesses more money to bring in new customers than it does to keep old customers happy and repeat customers are more profitable than new. This model helps them identify the different customers who are attempting to reach out to them and they can use this information to divert resources to those customers who hold the most potential value.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, social media is a collective of online communications channels dedicated to community-based input, interaction, content-sharing and collaboration. Social media differs from traditional paper-based media (e.g., magazines and newspapers) or electronic media such as TV broadcasting in many ways, including quality, reach, frequency, usability, immediacy, and permanence. Social media operates in a dialogic transmission system.

In many instances, social media is used as a communication tool, enabling like-minded users to communicate and develop relationships, based on common interests. Researchers have attributed social media's success to swift communications and its ability to create relationships. Being able to cultivate this type of relationship network through a company's social media campaign can affect consumers' intentions to buy products and services. Many sources indicate that companies are still using social media incorrectly, despite the vast amount of money invested.

It is known in the art that Facebook® is the most popular social media search engine. In January of 2014, Facebook®, the largest global social media site, reported a total of 1.19 billion users, a number that is growing at a rate of 18% year after year, with 729 million users logging in daily to interact with their networks. This popularity is generally acknowledged because Facebook® allows users to establish and create their own networks and interact with different groups as they choose.

Other proposals have involved creating interactive scenarios between consumers and merchants through social media networks. The problem with these social media systems gripping devices is that they do not allow a merchant to understand the consequences of ignoring consumer communications from the social media, nor do they assist merchants in creating proper responses to maintain these customer relationships. Also, the analytical breakdown of data from ignored consumers is not available. Even though the above cited social media systems meet some of the requests of the market, a system and method for merchant to evaluate sentiment of consumer through a social media network that helps a merchant, business, or organization to better understand the sentiments, intentions, and requests of a consumer who is attempting to communicate with the merchant through a social media network by identifying and analyzing consumer responses after being ignored on a social media network, is still desired.

### SUMMARY

Illustrative embodiments of the disclosure are generally directed to a system and method for merchant to evaluate sentiment of consumer through a social media network. The system and method helps a merchant, business, or organization to better understand the sentiments, intentions, and requests of a consumer who is attempting to communicate with the merchant through a social media network. The system and method also helps the merchant to better understand the reaction from the consumer and consequences for ignoring input from the consumer; based on the sentiments, intentions, and requests of the consumer impacts past, present, and future transactions. In this manner, the merchant does not miss opportunities to interact with the consumer, and also maintains relationships and a sense of community with a greater percentage of existing and future consumers, so as to possibly develop a consumer from a prospect to a brand ambassador.

In some embodiments, the merchant contextually obtains data about the consumer through observation of communications on social media. The idea is to streamline these communications so that the observation can be done efficiently and not create more roadblocks to hinder the communication between merchant and consumer. With the data, the merchant may utilize a communication modeling system, such as the Tingue Social Media Communication Nonresponse Model, to record the response of the consumer after the consumer input to the social media network has been ignored.

The communication modeling system includes: a consumer type portion (target consumer, prospect, new consumer, repeat consumer, and brand ambassador); a consumer request portion (marketing, information, support, and acknowledgement); and a consumer reaction portion (four of progression: engagement, conversion, repetition, and fruition; and four of regression: regression, stagnation, disillusionment and abandonment).

In one aspect, the method includes:
providing a social media network;
inputting into the social media network, by a consumer, a sentiment, intention, and request about a merchant;
if the consumer input is ignored by the merchant, responding through the social media network, by the consumer, the response pertinent to the ignored input;
identifying, by the merchant, the consumer response to the ignored input;
contextually obtaining data about the consumer, the data defining the effect on the consumer because of the ignored input;
analyzing, by the merchant, the data from the consumer through a communication modeling system, the communication modeling system including at least one of the following: a consumer type portion, a consumer request portion, and a consumer reaction portion;
analyzing, by the merchant the initial sentiment, intention, and request of the consumer through the communication modeling system;
responding to the initial sentiment, intention, and request of the consumer, by the merchant, the response based at least partially on the data from the consumer; and
maintaining a relationship, by the merchant, with the consumer.

In another aspect, the merchant is a business, organization, or brand.

In another aspect, the social media network includes at least one of the following: Facebook®, Snapchat®, Twitter®, LinkedIn® Instagram®, Pinterest®, and Reddit®.

In another aspect, the step of contextually obtaining data about the consumer, further comprises correctly identifying the consumer's position in the life cycle.

In another aspect, the consumer comprises at least one of the following consumer types: a prospect, a new consumer, a repeat consumer, and a brand ambassador.

In another aspect, the communication modeling system is a Tingue Social Media Communication Nonresponse Model.

In another aspect, the communication modeling system includes at least one of the following: a consumer type portion; a consumer request portion; and a consumer reaction portion

In another aspect, the consumer type portion includes: a target consumer, a prospect, a new consumer, a repeat consumer, and brand ambassador.

In another aspect, the consumer request portion comprises includes: marketing, information, support, and acknowledgement.

In another aspect, the consumer reaction portion includes progression action and regression action.

In another aspect, the progression action includes: engagement, conversion, repetition, and fruition.

In another aspect, the regression action includes: regression, stagnation, disillusionment, and abandonment.

One objective of the present invention is to help a merchant identify and respond to the sentiments, intentions, and needs of the consumer in an efficient manner.

Another objective is to address the needs of the consumer; whether the consumer is a prospect, new consumer, repeat consumer, or brand ambassador.

Yet another objective is to utilize the Tingue Social Media Communication Nonresponse Model for analysis of the consumer, and especially the consumer who is ignored on social media network.

Yet another objective is to study the interaction from the consumer's perspective, rather than from the merchant perspective, so that the merchant can then take this information and reach out to the 80% of consumers that are being ignored.

Yet another objective is to provide an inexpensive and easy to operate system and method for merchant to evaluate a causal relationship between answering and ignoring different types of communications on social media. For example, if a merchant ignores this type of communication sent by this type of customer, this is the action that the customer will take. Usually, the end action was to leave the company, creating a loss of revenue for the business

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary system for merchant to evaluate sentiment of consumer through a social media network, in accordance with an embodiment of the present invention;

FIG. 2 illustrates a block diagram of an exemplary communication modeling system, in accordance with an embodiment of the present invention;

FIGS. 3a, 3b, 3c and 3d illustrate four consumer analysis charts generated by a Tingue Social Media Communication Nonresponse Model, in accordance with an embodiment of the present invention; and

FIG. 4 illustrates a flowchart of an exemplary method for merchant to evaluate sentiment of consumer through a social media network, in accordance with an embodiment of the present invention.

Like reference numerals refer to like parts throughout the various views of the drawings.

### DETAILED DESCRIPTION OF THE INVENTION

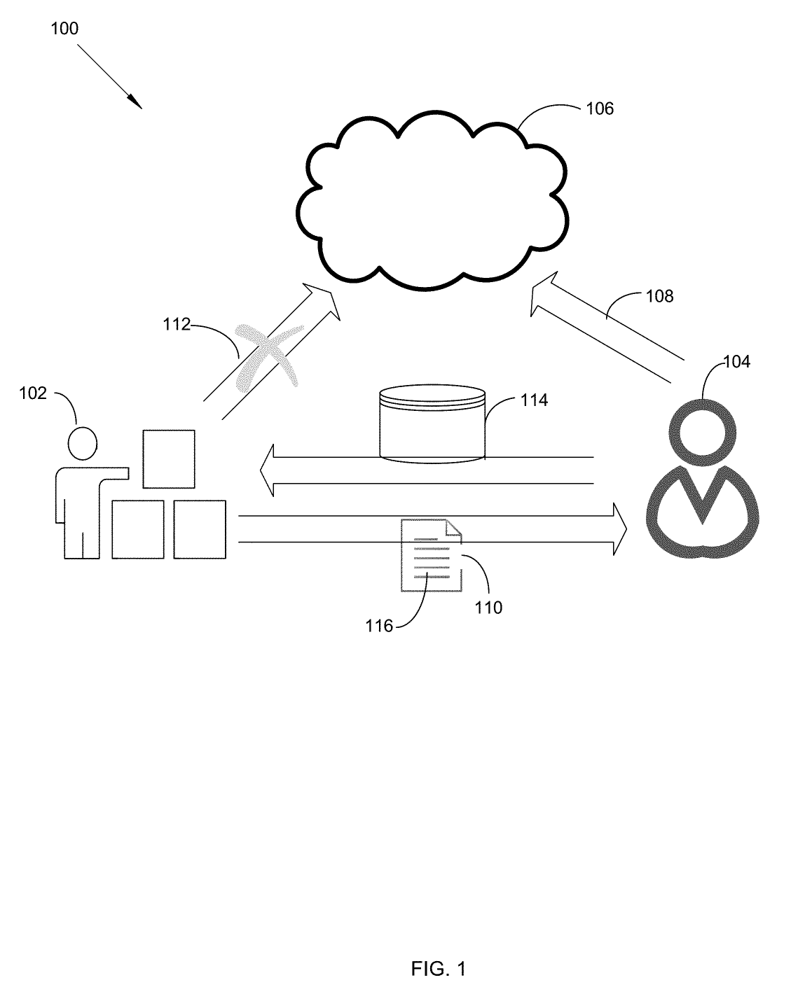

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 100 and method 700 for merchant to evaluate sentiment of consumer through a social media network is referenced in FIGS. 1-4. The system 100 and method 700 is a tool that can be used by a merchant 102 to better understand a consumer 104, and specifically, a consumer's interaction on a social media network 106. In this manner, the merchant 102 can better serve the needs of the consumer 104, and can more efficiently market products and services to the consumer 104.

Those skilled in the art will recognize that it costs businesses more money to bring in new customers than it does to keep old customers happy and repeat customers are more profitable than new. This model helps them identify the different customers who are attempting to reach out to them and they can use this information to divert resources to those customers who hold the most potential value.

As referenced in FIG. 1, system 100 helps a merchant 102, business, or organization to better understand the sentiments, intentions, and requests 108 of a consumer 104 who is attempting to communicate with merchant 102 through a social media network 106. Ironically, much of data 116 about the consumer is collected as a result of the merchant ignoring input 112, sentiment, intention, and request of the consumer 104.

Merchant 102 contextually obtains data 116 from consumer 104, so as to better understand resulting actions of consumer after being ignored, and also to correctly identify the consumer's position in the life cycle. A communication modeling system 114, and specifically a Tingue Social Media Communication Nonresponse Model processes the data, helping the merchant 102 to categorize the consumer and consumer requests 108 and reactions after being ignored. The modeling of the consumer 104 by the communication modeling system 114 facilitates the analysis by merchant 102.

In some embodiments, merchant 102 is a business, organization or brand. Though in other embodiments, the merchant may represent a marketing organization that serves merchants. The merchant transacts a product or service with the consumer. Merchant 102 is generally interested in marketing to the consumer 104 and collecting data that is pertinent to the consumer habits, needs, and reactions on social media network.

In some embodiments, the social media network 106 may include, without limitation, Facebook®, Snapchat®, Twitter®, LinkedIn® Instagram®, Pinterest®, and Reddit®. However in other embodiments, social media network 106 comprises any computer-mediated technologies that facilitate the creation and sharing of information, ideas, career interests and other forms of expression via virtual communities and networks.

In this manner, system 100 has implications for the field of social media marketing, particularly for the business purposes of communicating with consumers directly on a social media site, such as Facebook®. And thus, merchant 102 can use system 100 to successfully implement communications processes and protocols for identifying and responding to the sentiments, intentions, and requests of the consumer 104 directly on the social media network 106.

Thus, opportunities to communicate with the consumer online are not lost. Furthermore, the system 100 and method automates the process of interaction between merchant and consumer, both in identifying and answering sentiments, intentions, and requests of the consumer. However, automated responses are not always recommended, as per secondary research.

System 100 also helps the merchant to better understand how ignoring input from the consumer based on the sentiments, intentions, and requests of the consumer impacts past, present, and future transactions. In this manner, the merchant attempts to maintain relationships and a sense of community with a greater percentage of existing and future consumers, so as to possibly develop a consumer, from a prospect to a new consumer, to a repeat consumer, and finally to a brand ambassador.

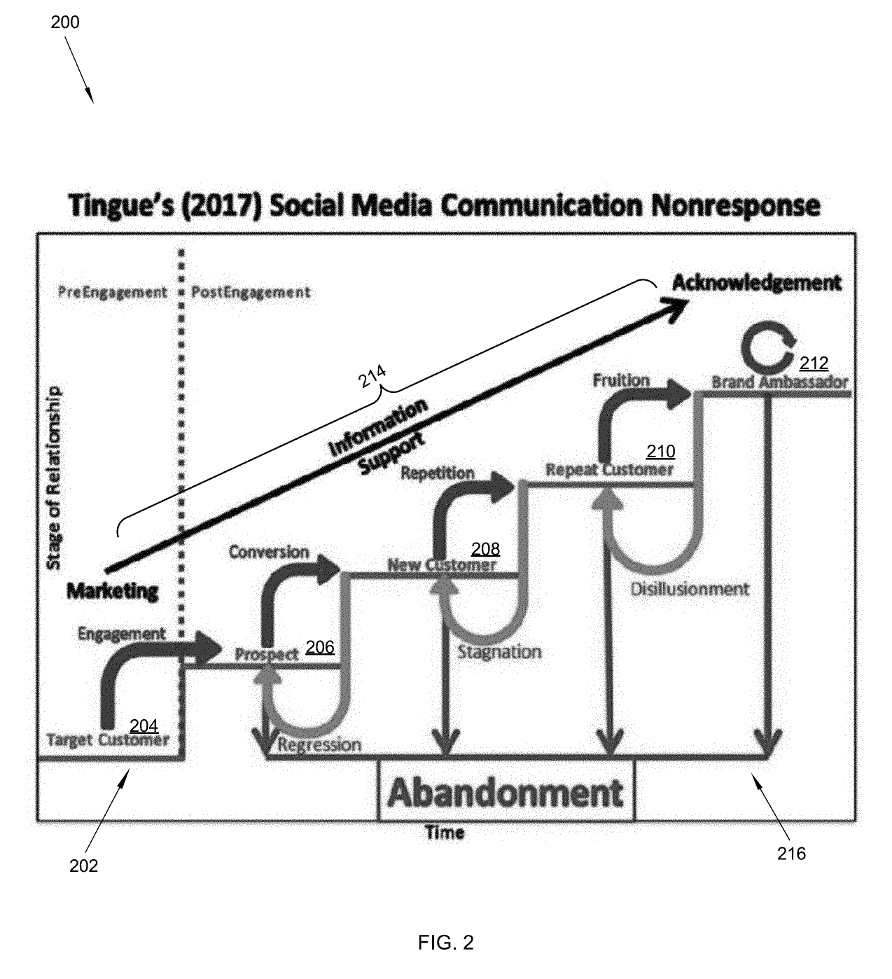

As referenced in FIG. 2, system 100 provides a communication modeling system 200 for analysis of consumer after requests are ignored. Communication modeling system 200 is an effective tool that merchant can use to analyze the type of consumer, the requests of the consumer on the social media network, and the reaction from the consumer upon the request being ignored by the merchant.

In one embodiment, communication modeling system 200 comprises a Tingue Social Media Communication Nonresponse Model, which is referenced in FIG. 2. Tingue Social Media Communication Nonresponse Model is adapted to chart the changing reactions and status of the consumer after the consumer input to the social media network has been ignored. In one embodiment, communication modeling system 200 includes: a consumer type portion 202. The categorization of consumers is as follows: target consumer 204, prospect 206, new consumer 208, repeat consumer 210, and brand ambassador 212.

In one embodiment, a prospect 206 is a potential consumer who has engaged with the brand on social media who is interested in potentially purchasing a product or service. At this stage the consumer is attempting to communicate with the brand or company in order to gather information about the company or the product or service that they are interested in, or to gain support, which will then influence their decision to form a relationship with the company. Those skilled in the art will recognize that the prospect consumer is generally looking for Information. Attentiveness is the most important factor: The merchant ideally answers to the prospect with respect, personal effort, empathy and willingness to listen; and in less than 12 hours.

In one embodiment, a new consumer 208 has completed the purchasing process. The new consumer is reaching out to the merchant, brand, or company in order to gain information about their product or service or are seeking post-purchase support (e.g., warrantee information, repairs, returns). Those skilled in the art will recognize that the new consumer is generally looking for information or support. The merchant ideally answers to the new consumer with a solution to the problem (Credibility); and in less than 36 hours.

A repeat consumer 210 has completed the purchasing process with the merchant multiple times. The repeat consumer is seeking additional support or information and is most likely to leave the consumer life cycle if they do not receive the expected interaction. Those skilled in the art will recognize that the repeat consumer is looking for support. It is important for the merchant to answer the repeat consumer with a solution to the problem. The merchant ideally answers to the repeat consumer with respect, personal effort, empathy and willingness to listen; and in less than 48 hours.

A brand ambassador 212 is generally a loyal consumer who has purchased many times from the merchant. The brand ambassador is often identified on the social media network as a consumer who answer other consumer's questions before the merchant, or who act as a brand expert or advocate. The brand ambassador does not expect responses from the merchant, but will accept and appreciate acknowledgement of their position and expertise with the brand. Rarely will the brand ambassador abandon the brand when they do not receive interactions from the merchant. Those skilled in the art will recognize that the brand ambassador is looking for acknowledgement. The merchant ideally answers the brand ambassador with respect, personal effort, empathy and willingness to listen; and also answers in less than 108 hours.

Communication modeling system further includes a consumer request portion 214. The categorization of consumer requests is as follows: marketing requests, information requests, support requests, and acknowledgement requests. The communication modeling system further includes a consumer reaction portion 216. The consumer reaction to being ignored includes the following for progression: engagement, conversion, repetition, and fruition.

Engagement by consumer includes the acceptance of the marketing message and first interactions with the merchant. Here, the consumer seeks out, ‘Likes’, or follows the merchant on the social media network. Conversion by the consumer includes seeking information about the merchant or product, or seeks support from the merchant, with the end goal being to purchase a product or service, thereby forming a relationship with the merchant. Repetition by the consumer includes seeking information on products or support regarding previous or future transactions, with the outcome of acquiring additional products or services from merchant. Fruition by the consumer includes acceptance that the merchant has met the needs of the consumer and the consumer creates an emotional relationship with the merchant.

The consumer reaction to being ignored includes the following for regression: regression, stagnation, disillusionment and abandonment. Regression by the consumer occurs after the merchant fails to provide needed information or support to the consumer in order to complete the purchase (should the consumer decide to give the merchant another chance), the consumer will revert back to being a prospect and begin the process of moving to a new consumer over again.

Stagnation by the consumer occurs if the merchant does not provide the needed support and information to convert a new consumer to a repeat consumer, the consumer will fail to purchase again and revert back to the new consumer position, if the consumer chooses to give the merchant another chance (rather than abandoning the relationship).

Disillusion by the consumer occurs if the merchant does not cement and encourage the emotional ties of the brand ambassador; the consumer can revert into a repeat consumer and stop acting as a brand expert or ambassador. Ultimately whether with repeated poor experiences or a massive failure by the merchant, the consumer may abandon. Action in terms of acknowledgment, ongoing service, and provision is needed to keep the consumer as an ambassador. Disillusion is the only stage where a consumer in the brand ambassador may leave the stage at any time and revert back to a repeat consumer.

Abandonment by the consumer may occur at any stage of the process, if a consumer does not receive the required communication from the merchant, the consumer could choose to leave the cycle and do business with another merchant.

As shown in the Tingue Social Media Communication Nonresponse Model of FIG. 2, an X-axis represents time, while a Y-axis represents the stages of a relationship between the merchant and consumer. As the consumer reaction portion 214 changes over time, the loyalty of the consumer increases, moving at an upward slope from target consumer 204, to prospect 206, to new consumer 208, to repeat consumer 210, and finally to brand ambassador 212. The effects of being ignored are also illustrated in the Tingue Social Media Communication Nonresponse Model, as the loyalty of the consumer decreases from disillusionment, to stagnation, and finally to regression, resulting in the consumer potentially abandoning the merchant.

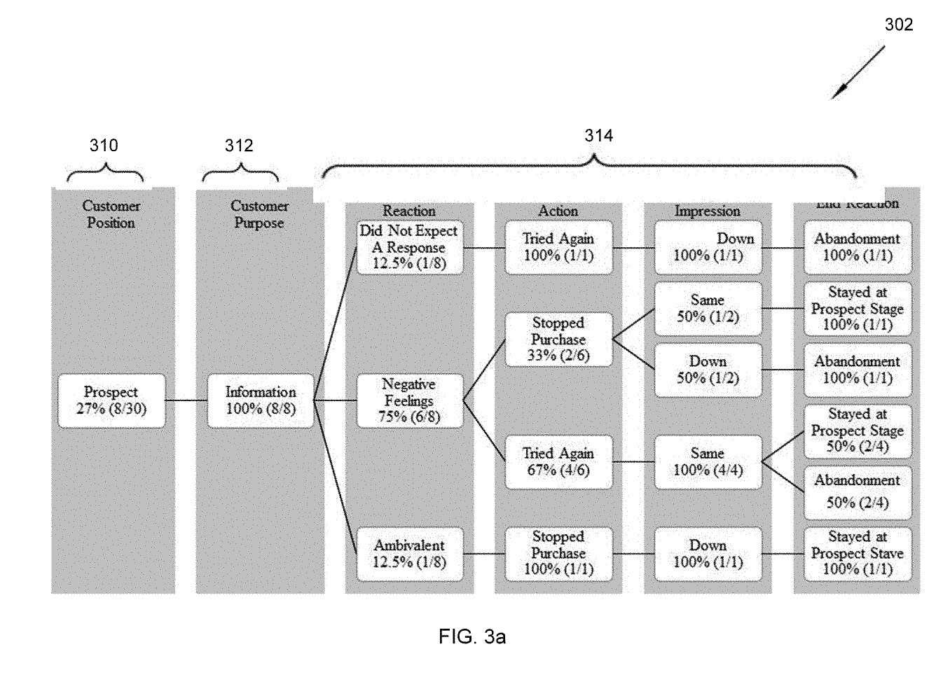

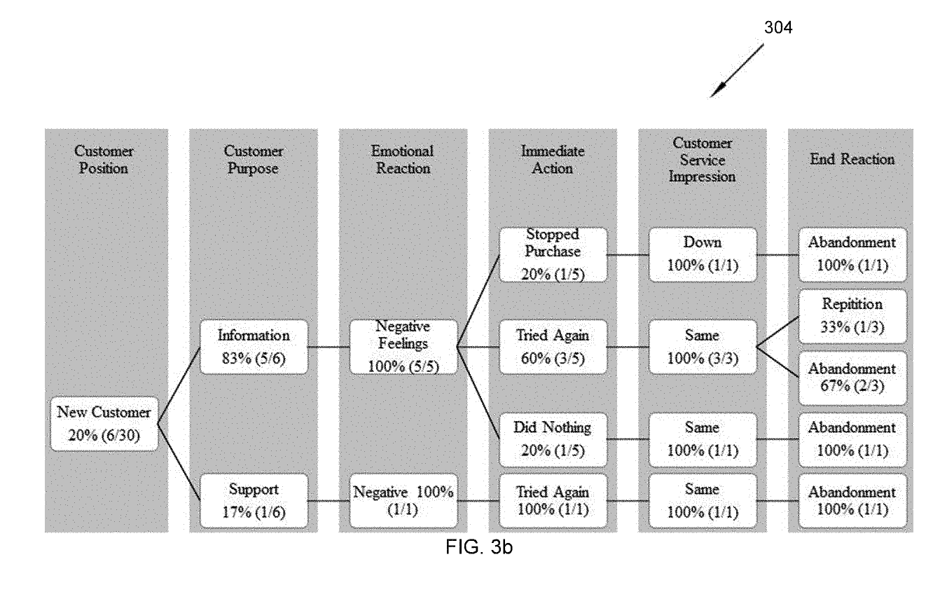

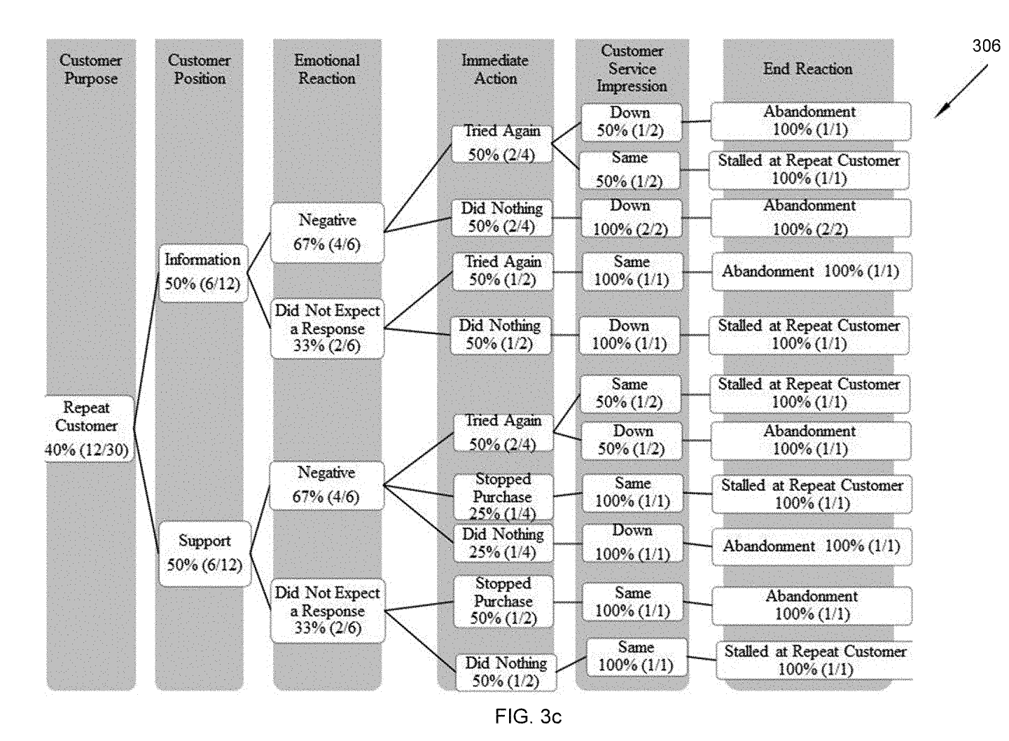

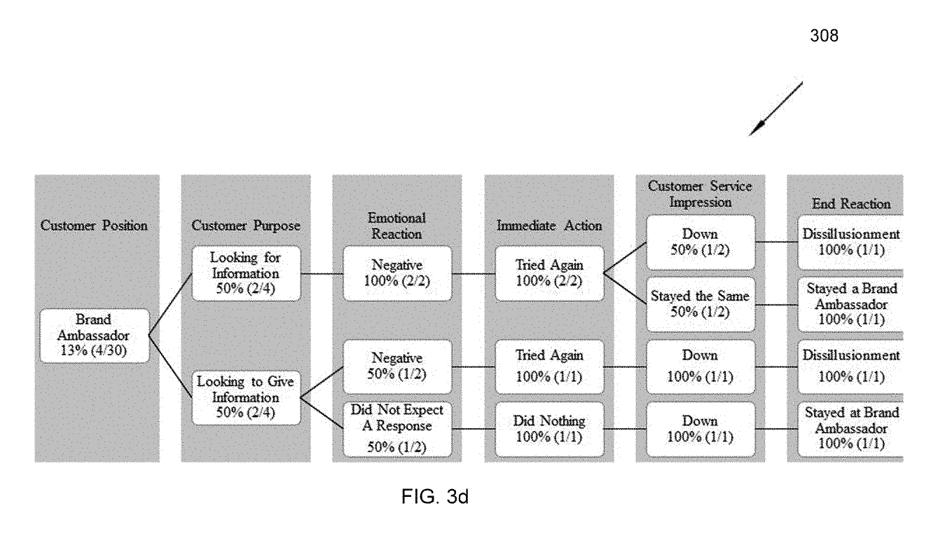

FIGS. 3a, 3b, 3c and 3d illustrate four consumer analysis charts generated by the Tingue Social Media Communication Nonresponse Model. Consumer analysis charts show the analysis for each type of consumer, i.e., consumer analysis chart for a prospect 302, consumer analysis chart for new consumer 304, consumer analysis chart for repeat consumer 306, and consumer analysis chart for brand ambassador 308. The request and reaction of each type of consumer is also presented for analysis by the merchant.

For example, consumer analysis chart for prospect 302 shows a consumer type portion 310, indicating the type of consumer. Consumer type portion illustrates that 27% of consumers are prospects. This can be useful information for merchant. Looking to the right of consumer type portion 310, a consumer request portion 312 shows that the consumer's purpose for contacting merchant on social media network was 100% for obtaining information. The consumer analysis chart also illustrates a consumer reaction portion 314 that references the emotional reaction: 12.5% did not expect a response; 75% had negative feelings; and 12.5% were ambivalent.

Continuing with the block analysis for target prospect 302, the consumer reaction portion 314 also references that 100% of the prospects attempted to contact the merchant again; and 33% ceased the transaction. The consumer reaction portion 314 also references the prospect's impression of the merchant. The consumer reaction portion 314 also references that 50% remained prospects; and 50% abandoned the merchant. This percentile information about the consumer helps merchant better understand the quantitative breakdown of multiple consumers.

Appendix A references a study that shows the creation of the Tingue Social Media Communication Nonresponse Model. The study is titled: SOCIAL MEDIA MARKETING: EXPLORING EFFECTIVE CUSTOMER TO BUSINESS INTERACTIONS WITH THE FORGOTTEN 80%. In this study, Tingue Social Media Communication Nonresponse Model is used to analyze the data. Tingue Social Media Communication Nonresponse Model also categorizes the data through consumer analysis charts and other empirical tools.

Turning now to FIG. 4, a method 700 for merchant to evaluate sentiment of consumer through a social media network comprises an initial Step 702 of providing a social media network. In some embodiments, the social media network 106 may include, without limitation, Facebook®, Snapchat®, Twitter®, LinkedIn® Instagram®, Pinterest®, and Reddit®. However in other embodiments, social media network 106 comprises any computer-mediated technologies that facilitate the creation and sharing of information, ideas, career interests and other forms of expression via virtual communities and networks.

A Step 704 further comprises inputting into the social media network, by a consumer, a sentiment, intention, and request about a merchant. The consumer comprises at least one of the following consumer types: a prospect, a new consumer, a repeat consumer, and a brand ambassador. If the consumer input is ignored by the merchant, a Step 706 includes responding through the social media network, by the consumer, the response pertinent to the ignored input. Consumer may resent the initial request or show dissatisfaction through reviews or direct messages to the merchant.

In some embodiments, a Step 708 comprises identifying, by the merchant, the consumer response to the ignored input. Merchant can search social media network 106. It is apparent through observation whether the customer has been responded to. This is useful for determining whether consumer 104 has been ignored. The idea is to streamline these communications so that the observation can be done efficiently and not create more roadblocks to hinder the communication between merchant and consumer.

Another Step 710 includes contextually obtaining data about the consumer, the data defining the effect on the consumer because of the ignored input. In some embodiments, the data is obtained through observation. With the data, the merchant may utilize a communication modeling system, such as the Tingue Social Media Communication Nonresponse Model, to record the response of the consumer after the consumer input to the social media network has been ignored.

A Step 712 may include analyzing, by the merchant, the data from the consumer through a communication modeling system, the communication modeling system including at least one of the following: a consumer type portion, a consumer request portion, and a consumer reaction portion. A Step 714 includes analyzing, by the merchant the initial sentiment, intention, and request of the consumer through the communication modeling system. Another Step 716 includes responding to the initial sentiment, intention, and request of the consumer, by the merchant, the response based at least partially on the data from the consumer. A final Step 718 comprises maintaining a relationship, by the merchant, with the consumer.

Those skilled in the art will recognize that the merchant must view each consumer as unique and individual, the amount of time and how much support and information is needed from the merchant differs, depending on the type of consumer. The communication modeling system shows that consumers who are in the lower stages of the model require more information and less support. The consumers in the upper stages require more support and less information. The two are not mutually exclusive and will always be needed to some degree. The difference is based on the perceived needs of the consumer at that point in time. It is significant to note that ignoring the sentiment, intention, and request of the consumer, or nonresponses, push consumers backward in model (regression) and may be seen as failing to fulfill consumer needs.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method for a merchant to evaluate the purchasing position of a consumer and predict future purchasing behaviors through interactions on a social media network, the method comprising:
providing a social media network;
inputting into the social media network, by a consumer, a sentiment, intention, and request about a merchant;
if the consumer input is ignored by the merchant, responding through the social media network, by the consumer, the response pertinent to the ignored input;
identifying, by the merchant, the consumer response to the ignored input;
contextually obtaining data about the consumer, the data defining the effect on the consumer because of the ignored input;
analyzing, by the merchant, the data from the consumer through a communication modeling system, the communication modeling system including at least one of the following: a consumer type portion, a consumer request portion, and a consumer reaction portion;
analyzing, by the merchant the initial sentiment, intention, and request of the consumer through the communication modeling system;
responding to the initial sentiment, intention, and request of the consumer, by the merchant, the response based at least partially on the data from the consumer; and
maintaining a relationship, by the merchant, with the consumer.

2. The method of claim 1, further comprising a step of generating a consumer analysis chart with the communication modeling system.

3. The method of claim 2, wherein the step of analyzing, by the merchant, the data from the consumer, further comprises analyzing the consumer analysis chart to determine the initial sentiment, intention, and request of the consumer.

4. The method of claim 1, further comprising a step of requesting a review of the merchant from the consumer.

5. The method of claim 1, wherein the merchant includes at least one of the following: a business, an organization, and a brand.

6. The method of claim 1, wherein the step of contextually obtaining data about the consumer, further comprises correctly identifying the consumer's position in the life cycle.

7. The method of claim 1, wherein the social media network includes at least one of the following: Facebook®, Snapchat®, Twitter®, LinkedIn® Instagram®, Pinterest®, and Reddit®.

8. The method of claim 1, wherein the consumer comprises at least one of the following consumer types: a prospect, a new consumer, a repeat consumer, and a brand ambassador.

9. The method of claim 1, wherein the communication modeling system is a Tingue Social Media Communication Nonresponse Model.

10. The method of claim 9, wherein the consumer type portion includes: a target consumer, a prospect, a new consumer, a repeat consumer, and a brand ambassador.

11. The method of claim 10, wherein the consumer request portion includes: marketing, information, support, and acknowledgement.

12. The method of claim 11, wherein the consumer reaction portion includes: a progression sentiment and a regression sentiment.

13. The method of claim 12, wherein the progression sentiment includes: engagement, conversion, repetition, and fruition.

14. The method of claim 13, wherein the regression sentiment includes: regression, stagnation, disillusionment, and abandonment.

15. A method for a merchant to evaluate sentiment of a consumer through a social media network, the method consisting of:
providing a social media network;
inputting into the social media network, by a consumer, a sentiment, intention, and request about a merchant;
if the consumer input is ignored by the merchant, responding through the social media network, by the consumer, the response pertinent to the ignored input;
identifying, by the merchant, the consumer response to the ignored input;
contextually obtaining data about the consumer, the data defining the effect on the consumer because of the ignored input;
analyzing, by the merchant, the data from the consumer through a communication modeling system, the communication modeling system including at least one of the following: a consumer type portion, a consumer request portion, and a consumer reaction portion,
whereby the consumer type portion includes: a target consumer, a prospect, a new consumer, a repeat consumer, and a brand ambassador,
whereby the consumer request portion includes: marketing, information, support, and acknowledgement,
whereby the consumer reaction portion includes: a progression sentiment and a regression sentiment;
generating a consumer analysis chart with the communication modeling system;
analyzing, by the merchant, the consumer analysis chart to determine the initial sentiment, intention, and request of the consumer;
responding to the initial sentiment, intention, and request of the consumer, by the merchant, the response based at least partially on the data from the consumer;
maintaining a relationship, by the merchant, with the consumer; and
requesting a review of the merchant from the consumer.

16. The method of claim 15, wherein the progression sentiment includes: engagement, conversion, repetition, and fruition.

17. The method of claim 16, wherein the regression sentiment includes: regression, stagnation, disillusionment, and abandonment.

18. The method of claim 17, wherein the communication modeling system is a Tingue Social Media Communication Nonresponse Model.

19. The method of claim 18, wherein the social media network includes at least one of the following: Facebook®, Snapchat®, Twitter®, LinkedIn® Instagram®, Pinterest®, and Reddit®.

20. A system for a merchant to evaluate sentiment of a consumer through a social media network, the system comprising:
a social media network accessible by a merchant and a consumer,
whereby the consumer inputs information pertinent to the merchant through the social media network;
a communication modeling system for analyzing the data, the communication modeling system including at least one of the following: a consumer type portion, a consumer request portion, and a consumer reaction portion,
whereby the consumer type portion includes: a target consumer, a prospect, a new consumer, a repeat consumer, and a brand ambassador,
whereby the consumer request portion includes: marketing, information, support, and acknowledgement,
whereby the consumer reaction portion includes: a progression sentiment and a regression sentiment; and
a consumer analysis chart generated by the communication modeling system,
whereby the consumer analysis chart enables the merchant to respond to the consumer based at least partially on the data from the consumer.
